(19) United States
(12) Patent Application Publication
(10) Pub. No.: US 2024/0371280 A1
(43) Pub. Date: Nov. 7, 2024

(54) METHODS AND APPARATUSES FOR UNMANNED AERIAL VEHICLE USER EQUIPMENT REPLACEMENT

(71) Applicant: LENOVO (BEIJING) LIMITED, Beijing (CN)

(72) Inventors: Jie HU, Beijing (CN); Jing HAN, Beijing (CN); Haiming WANG, Beijing (CN); Min XU, Beijing (CN)

(21) Appl. No.: 18/554,078

(22) PCT Filed: Apr. 9, 2021
(86) PCT No.: PCT/CN2021/086249

§ 371 Date: Oct. 5, 2023

(51) Int. Cl. G08G 5/00

(52) U.S. Cl. CPC G08G 5/0069; G08G 5/0013

(57) ABSTRACT

The present application relates to methods and apparatuses for unmanned aerial vehicle user equipment replacement. An embodiment of the present disclosure provides a method for replacing an unmanned aerial vehicle (UAV) user equipment (UE) within a UAV swarm including a plurality of UAV UEs. The method may include: transmitting a first replacement command comprising first information related to a first UAV UE to a second UAV UE, wherein the second UAV UE is to replace the first UAV UE from the UAV swarm; and in response to receiving an acknowledgement to the first replacement command from the second UAV UE, transmitting a second replacement command including second information related to the second UAV UE to one or more UAV UEs of the UAV swarm other than the first UAV UE.

### TECHNICAL FIELD

The subject disclosure relates to wireless communication technologies, and more particularly, the subject disclosure relates to methods and apparatuses for unmanned aerial vehicle (UAV) user equipment (UE) replacement.

### BACKGROUND OF THE INVENTION

An unmanned aerial vehicle (UAV) swarm (also referred to as “UAV group”) including a plurality of UAV UEs can be seen as a logic group of UAV UEs which is managed by a network or a master UAV UE in the swarm, and UAV UEs in the swarm may communicate with each other by using sidelink.

With restrictions on transmitting distance, low battery life and inefficient swarming algorithm, a self-organized UAV swarm has limited capability in detecting incidents and recovering from them, which might render a task assigned to the UAV swarm failed.

### SUMMARY

Embodiments of the present disclosure provide at least a solution for unmanned aerial vehicle (UAV) user equipment (UE) replacement within a UAV swarm including a plurality of UAV UEs, to replace a UE (e.g., a UAV) which cannot perform a normal operation for the UAV swarm.

An embodiment of the present disclosure provides a method for replacing a UAV UE within a UAV swarm including a plurality of UAV UEs. The method may include: transmitting a first replacement command including first information related to a first UAV UE to a second UAV UE, wherein the second UAV UE is to replace the first UAV UE from the UAV swarm; and in response to receiving an acknowledgement to the first replacement command from the second UAV UE, transmitting a second replacement command including second information related to the second UAV UE to one or more UAV UEs of the UAV swarm other than the first UAV UE.

In an embodiment of the present disclosure, the acknowledgement may include at least one of the following: UE capabilities for different radio access technologies (RATs) of the second UAV UE, location information of the second UAV UE, or one or more measurement results of the second UAV UE.

In an embodiment of the present disclosure, the acknowledgement is received along with at least one of the following: UE capabilities for different RATs of the second UAV UE, location information of the second UAV UE, or one or more measurement results of the second UAV UE.

In an embodiment of the present disclosure, the method may further include transmitting a configuration to the second UAV UE to configure the second UAV UE as a backup UAV UE for any UAV UE of the UAV swarm, a backup UAV UE for the first UAV UE of the UAV swarm, or a backup UAV UE for any UAV UE of a plurality of UAV swarms including the UAV swarm.

In an embodiment of the present disclosure, the configuration is transmitted in a dedicated RRC signaling or a system information block (SIB).

In an embodiment of the present disclosure, the method may further include: determining the first UAV UE and the second UAV UE based on a result of incident detection or control command from a central controller; and transmitting an indication to activate the second UAV UE.

In an embodiment of the present disclosure, the method may further include reporting the determined first UAV UE and the determined second UAV UE to a base station.

In an embodiment of the present disclosure, the first information related to the first UAV UE may include at least one of the following parameters: a UE identifier, location information, and a flight path of the first UAV UE; an identification and a flight path of the UAV swarm; a UE context of the first UAV UE; slice related information of the first UAV UE; a UE identifier, location information, a flight path, and UE capabilities for different RATs of a UAV UE of the UAV swarm other than the first UAV UE; or one or more measurement reports received by the first UAV UE.

In an embodiment of the present disclosure, the second information related to the second UAV UE may include at least one of: a UE identifier of the second UAV UE, location information of the second UAV UE, a set of resources for establish a sidelink connection with the second UAV UE, an association between the set of resources and the one or more UAV UEs of the UAV swarm, or an indication to stop transmission with the first UAV UE.

In an embodiment of the present disclosure, the second replacement command is transmitted when location information of the second UAV UE is within a first range or a measurement result of the second UAV UE is within a second range.

In an embodiment of the present disclosure, the method may further include determining a successful replacement of the first UAV UE by the second UAV UE based on: a successful sidelink connection between the second UAV UE and one or more UAV UEs of the UAV swarm; and a measurement result related to the second UAV UE within a predefined range.

In an embodiment of the present disclosure, the measurement result may include measured location information of the second UAV UE, or a sidelink reference signal received power (SL-RSRP) of the second UAV UE for the established sidelink connection.

In an embodiment of the present disclosure, the method may further include receiving the measurement result from the second UAV UE or the one or more UAV UEs of the UAV swarm.

In an embodiment of the present disclosure, the method may further include performing a measurement to obtain the measurement result.

In an embodiment of the present disclosure, the method may further include transmitting a replacement completion indication to the one or more UAV UEs of the UAV swarm when it is determined that the replacement of the first UAV UE with the second UAV UE is successful, wherein the replacement completion indication may include a UE identifier and location information of the second UAV UE, and an indication indicating that the second UAV UE has replaced the first UAV UE and joined in the UAV swarm.

In an embodiment of the present disclosure, the method may further include transmitting a replacement failure indication to the one or more UAV UEs of the UAV swarm when it is determined that the replacement of the first UE with the second UAV UE is not successful, wherein the replacement failure indication may include a UE identifier and location information of the first UAV UE and an indication to stop transmission with the first UAV UE.

Another embodiment of the present disclosure provides a method for replacing a UAV UE within a UAV swarm including a plurality of UAV UEs. The method may include: receiving, at a second UAV UE, a first replacement command including first information related to a first UAV UE, wherein the second UAV UE is to replace the first UAV UE from the UAV swarm; transmitting an acknowledgement to the first replacement command; and establishing a sidelink connection between the second UAV UE and one or more UAV UEs of the UAV swarm other than the first UAV UE.

In an embodiment of the present disclosure, the acknowledgement may include at least one of the following: UE capabilities for different RATs of the second UAV UE, location information of the second UAV UE, or one or more measurement results of the second UAV UE.

In an embodiment of the present disclosure, the acknowledgement is transmitted along with at least one of the following: UE capabilities for different RATs of the second UAV UE, location information of the second UAV UE, or one or more measurement results of the second UAV UE.

In an embodiment of the present disclosure, the method may further include receiving a configuration to configure the second UAV UE as a backup UAV UE for any UAV UE of the UAV swarm, a backup UAV UE for the first UAV UE of the UAV swarm, or a backup UAV UE for any UAV UE of a plurality of UAV swarms including the UAV swarm.

In an embodiment of the present disclosure, the configuration is received from a base station, a master UAV UE of the UAV swarm, or a UAV UE central controller.

In an embodiment of the present disclosure, the configuration is received in a dedicated RRC signaling or a SIB.

In an embodiment of the present disclosure, the second UAV UE is pre-configured as a backup UAV UE for any UAV UE of the UAV swarm, a backup UAV UE for the first UAV UE of the UAV swarm, or a backup UAV UE for any UAV UE of a plurality of UAV swarms including the UAV swarm.

In an embodiment of the present disclosure, the method may further include receiving an indicator to activate the second UAV UE.

In an embodiment of the present disclosure, the first information related to the first UAV UE may include at least one of the following parameters: a UE identifier, location information, and a flight path of the first UAV UE; an identification and a flight path of the UAV swarm; a UE context of the first UE; slice related information of the first UAV UE; a UE identifier, location information, a flight path, and UE capabilities for different RATs of a UAV UE of the UAV swarm other than the first UAV UE; or one or more measurement reports received by the first UAV UE.

In an embodiment of the present disclosure, the first UAV UE is a master UAV UE of the UAV swarm, and the method may further include: receiving a measurement or location information report via the established sidelink connection; and transmitting the measurement or location information report to a base station.

In an embodiment of the present disclosure, the method may further include performing a measurement on the established sidelink connection to obtain a measurement result; and transmitting the measurement result.

In an embodiment of the present disclosure, the measurement result may include measured location information of the second UAV UE, or an SL-RSRP of the second UAV UE for the established sidelink connection.

Yet another embodiment of the present disclosure provides an apparatus, which includes: a processor; and a transceiver coupled to the processor, wherein the processor is configured to: transmit, via the transceiver, a first replacement command including first information related to a first UAV UE to a second UAV UE, wherein the second UAV UE is to replace the first UAV UE from an UAV swarm including a plurality of UAV UEs; and in response to receiving an acknowledgement to the first replacement command from the second UAV UE, transmit, via the transceiver, a second replacement command including second information related to the second UAV UE to one or more UAV UEs of the UAV swarm other than the first UAV UE.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIGS. 1A-1C illustrate schematic diagrams of exemplary wireless communication systems in accordance with some embodiments of the present disclosure.

FIG. 2 illustrates a flow chart of an exemplary UAV UE replacement process according to some embodiments of the present disclosure.

FIG. 3 illustrates a flow chart of an exemplary UAV UE replacement process according to some other embodiments of the present disclosure.

FIG. 4 illustrates a flow chart of an exemplary method for wireless communication according to some embodiments of the present disclosure.

FIG. 5 illustrates an exemplary block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that not all illustrated operations need be performed. For example, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd Generation Partnership Project (3GPP) 5G, 3GPP Long Term Evolution (LTE) and so on. Persons skilled in the art know very well that, with the development of network architecture and new service scenarios, the embodiments in the present disclosure are also applicable to similar technical problems; and moreover, the terminologies recited in the present disclosure may change, which should not affect the principle of the present disclosure.

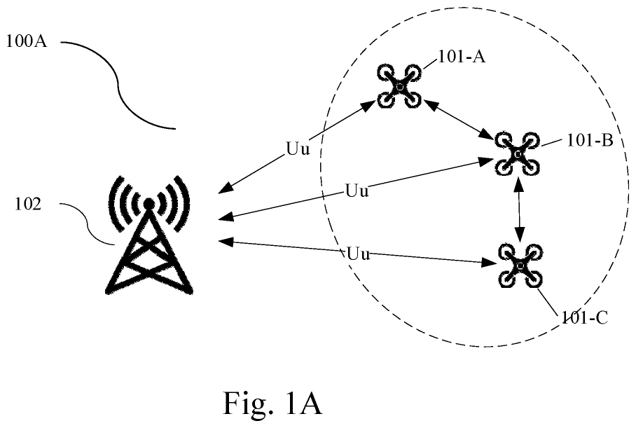

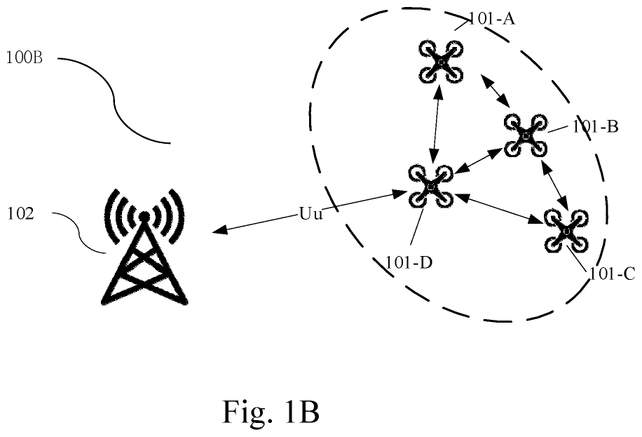

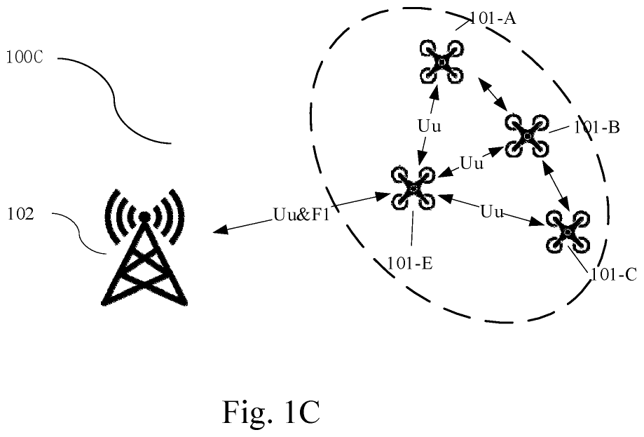

FIGS. 1A-1C illustrate schematic diagrams of exemplary wireless communication systems in accordance with some embodiments of the present disclosure.

FIG. 1A illustrates a schematic diagram of a wireless communication system 100A, e.g., an unmanned aerial system (UAS). In FIG. 1A, the wireless communication system 100A includes a UAV swarm, which includes a UAV UE 101-A, a UAV UE 101-B, and a UAV UE 101-C, and a base station (BS) 102. Even though a specific number of UAV UEs and BS are depicted in FIG. 1A, persons skilled in the art will recognize that any number of UAV UEs and BSs may be included in the wireless communication system 100A.

The BS 102 may be distributed over a geographic region. In certain embodiments, the BS 102 may also be referred to as an access point, an access terminal, a base, a macro cell, a Node-B, an enhanced Node B (eNB), a gNB, a Home Node-B, a relay node, or any device described using other terminology used in the art. The BS 102 is generally parts of a radio access network that may include one or more controllers communicably coupled to one or more corresponding BSs.

The wireless communication system 100A is compatible with any type of network that is capable of sending and receiving wireless communication signals. For example, the wireless communication system 100A is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3rd Generation Partnership Project (3GPP)-based network, a 3GPP 5G network, a satellite communications network, a high altitude platform network, and/or other communications networks.

In some embodiments, the wireless communication system 100A is compatible with the 5G new radio (NR) of the 3GPP protocol, wherein the BSs transmit data using an orthogonal frequency division multiplexing (OFDM) modulation scheme on the downlink and the UAV UEs transmit data on the uplink using a Discrete Fourier Transform-Spread-Orthogonal Frequency Division Multiplexing (DFT-S-OFDM) or a Cyclic Prefix-Orthogonal Frequency Division Multiplexing (CP-OFDM) scheme. More generally, the wireless communication system 100A may implement some other open or proprietary communication protocols, for example, WiMAX, among other protocols.

In some other embodiments, the BS 102 may communicate using other communication protocols, such as the IEEE 802.11 family of wireless communication protocols. Further, in some embodiments, the BS 102 may communicate over licensed spectrums, whereas in other embodiments the BS 102 may communicate over unlicensed spectrums. The present disclosure is not intended to be limited to the implementation of any particular wireless communication system architecture or protocol. In another embodiment, the BS 102 may communicate with the UAV UEs using 3GPP 5G protocols.

The UAV UEs 101-A, 101-B, and 101-C may include UAVs, unmanned vehicles, or other user equipment, which are grouped together to achieve a specific task. In some embodiments, the UAV swarm may also be referred to as a UAV group. In FIG. 1A, each of the UAV UE 101-A, the UAV UE 101-B, and the UAV UE 101-C in the UAV swarm has the capability to communicate with the BS 102, and the UAV swarm can be seen as a logic group of UEs by the network. The UAV UE 101-A, the UAV UE 101-B, and the UAV UE 101-C can communicate with each other by sidelink, and communicate with the BS 102 via Uu interface.

FIG. 1B illustrates a schematic diagram of an exemplary wireless communication system 100B in accordance with some embodiments of the present disclosure, which relates to another deployment scenario of a UAV swarm. Compared with the wireless communication system 100A, the wireless communication system 100B further includes a UAV UE 101-D, which manages the UAV swarm including the UAV UE 101-A, the UAV UE 101-B, the UAV UE 101-C, and the UAV UE 101-D. The UAV UE 101-D communicates with the BS 102 via Uu interface. The UAV UE 101-D may be referred to as a master UAV UE, a primary UAV UE, a leader UAV UE, etc. Other UAV UEs (e.g., the UAV UE 101-A, the UAV UE 101-B, and the UAV UE 101-C) in the swarm may be referred to as member UAV UEs. In the wireless communication system 100B, only the master UAV UE 101-D has the capability to communicate with the BS 102. Other UAV UEs in the swarm cannot communicate with the BS 102 but can communicate with the master UAV UE 101-D and with each other via sidelink or non-3GPP protocol, e.g. Wi-Fi.

FIG. 1C illustrates a schematic diagram of an exemplary wireless communication system 100C in accordance with some embodiments of the present disclosure, which includes a UAV swarm relayed by a UAV. Compared with the wireless communication system 100B, the wireless communication system 100C includes a UAV relay node (e.g., a UAV UE 101-E) instead of the master UAV UE 101-D. More specifically speaking, the UAV UE 101-E functions as a relay (e.g. as an Integrated Access Backhaul (IAB) node) and forwards data for other UAV UEs in the swarm including the UAV UE 101-A, the UAV UE 101-B, the UAV UE 101-C, and the UAV UE 101-E. The UAV relay node UE 101-E may be static or moving together with other UAV UEs in the swarm. Other UAV UEs in the swarm, e.g. UAV UE 101-A, UAV UE 101-B, and UAV UE 101-C can communicate with the UAV UE 101-E via Uu interface, and can communicate with each other via sidelink. The UAV UE 101-E can communicate with the BS 102 via Uu interface or F1 interface.

Considering the highly dynamic topology which may cause frequent breaks in radio connectivity, for example, due to restrictions of transmitting distance, low battery life and inefficient swarming algorithm, a self-organized UAV swarm has limited capability in detecting incidents (e.g. dropping out of an individual UAV UE) and recovering from them, and the UAV UE encountering incidents may not be able to catch up with the swarm without further assistance, which might render a task assigned to the UAV swarm failed.

In order to address the problems, and achieve more efficient and reliable work for UAV swarm, the present disclosure introduces one or more backup UAV UEs, which are allocated to one or more UAV swarms to assist the swarms for quick recovery from the incidents occurred in an individual UAV UE (e.g. dropping out of an individual UAV UE).

The present disclosure focuses on the deployment scenarios of UAV swarms as depicted in FIGS. 1A and 1B. That is, each member UAV UE in the UAV swarm is managed by a BS, or a master UAV UE in the UAV swarm manages member UAV UEs.

In order to replace a UAV UE in a UAV swarm when the UAV UE encounters an incident, one or more backup UAV UEs may be configured or pre-configured. The one or more backup UAV UEs may be in or outside the UAV swarm. A backup UAV UE may be specific for one UAV swarm or may be common for multiple UAV swarms. The backup UAV UE may be specific for one UAV UE or may be common for multiple UAV UEs. These cases are further described as follows:

Case 1: one or more backup UAV UEs are configured or pre-configured for a specific UAV swarm, i.e. the one or more backup UAV UEs may be used to replace any UAV UE in this UAV swarm. For example, a backup UAV UE is only configured for the UAV swarm shown in FIG. 1B, and the backup UAV UE may replace the master UAV UE (e.g., UAV UE 101-D), or any member UAV UE (e.g., UAV UE 101-A, UAV UE 101-B, or UAV UE 101-C). The backup UAV UE may be configured with information of the UAV swarm, which includes an identification of the UAV swarm, and information of each UAV UE in the UAV swarm, such as a UE identifier (ID), location information, a fight path, etc.

Case 2: one or more backup UAV UEs are configured or pre-configured for a specific UAV UE, i.e. the one or more backup UAV UEs may replace a specific UAV UE (e.g. the master UAV UE) in a UAV swarm. For example, a backup UAV UE is only configured for the master UAV UE (e.g., UAV UE 101-D) as shown in FIG. 1B. The backup UAV UE may be configured with information of the specific UAV UE in the UAV swarm, which includes an identifier of the specific UAV UE, a flight path, and information of the UAV swarm.

Case 3: one or more backup UAV UEs are configured or pre-configured common for multiple UAV UEs or for multiple UAV swarms. In this case, a backup UAV UE can replace any UAV UE in those UAV swarms, and the specific UAV UE to be replaced by the backup UAV UE is indicated by a detailed command for activation received by the backup UAV UE.

In some embodiments of the present disclosure, the above configuration for a backup UAV UE (also referred to as “backup UAV UE configuration”) may be transmitted from the network (e.g., from a BS) by dedicated radio resource control (RRC) signaling, or broadcasted by system information block (SIB) signaling when the backup UAV UE is in coverage of the network. In some other embodiments of the present disclosure, in a swarm managed by a UAV UE (i.e. the master UAV UE), the BS may provide such configuration to the master UAV UE, and the master UAV UE may then provide the configuration to the backup UAV UE. Additionally, in the case that the BS does not provide the configuration to the backup UAV UE (e.g., when the backup UAV UE is out of coverage of the network), the above configuration can be pre-configured in the backup UAV UE. In another embodiment, the backup UAV UE is configured or controlled by a UAV UE central controller. In this embodiment, the flight operation is pre-programmed for each backup UAV UE. In another embodiment, the backup UAV UE is configured or controlled by the master UAV UE.

Based on the above configuration for the backup UAV UE, when an incident happens to a UAV UE in a UAV swarm and the UAV UE needs to be replaced, the backup UAV UE will be activated. The backup UAV UE activation may be controlled by different objects in different scenarios as follows.

Scenario 1: an application layer controls the backup UAV UE activation. Specifically, the application layer activates one or more backup UAV UEs to replace one or more specific UAV UEs based on detected incidents in a Non-Access Stratum (NAS) layer.

Scenario 2: a BS controls the backup UAV UE activation. In this scenario, the BS determines one or more specific UAV UEs to be replaced and indicates one or more backup UAV UEs to be activated (i.e., to stop pending and start preparing to replace the specific UAV UEs). The BS performs incident detection for UAV UEs in the UAV swarm, determines the UAV UE(s) to be replaced and corresponding backup UAV UE(s) based on the incident detection mechanism or results.

Scenario 3: the master UAV UE in the UAV swarm controls the backup UAV UE activation. In particular, the master UAV UE determines the specific UAV UE(s) to be replaced and indicates the backup UAV UE(s) to stop pending and start preparing to replace the specific UAV UE(s). The master UAV UE performs incident detection for UAV UEs in the UAV swarm and determines the UAV UE(s) to be replaced and corresponding backup UAV UE(s) based on the incident detection mechanism or results. The master UAV UE may report information of the UAV UE(s) to be replaced and corresponding backup UAV UE(s) to its serving BS.

Incident detection mechanism aims to help a UAV swarm to detect potential incidents and recover from them. The mechanism can be performed in either a NAS layer or an Access Stratum (AS) layer.

For incident detection in a NAS layer, a central controller for a UAV swarm monitors and controls operations of the UAV swarm by intelligent algorithms. Such controller can be a ground control software running in a computer. It can communicate with each UAV UE and exchange command or data like GPS information, groundspeed, and other parameters collected from payload sensors. Therefore, when the controller detects that the data of a specific UAV UE is abnormal, it can transmit an indicator or command to the serving BS or the master UAV UE of the abnormal UE to initiate the backup UAV UE activation, or activate the backup UAV UE directly.

For incident detection in an AS layer, it supports fast incident detection and recovery by signaling interaction in the AS layer. The BS or the master UAV UE detects the incidents (e.g. UAV dropping out, inter-UAV spacing control, limited capability) by the measurement reporting, e.g. RSRP value, or location information from each UAV UE, and determines the abnormal UAV UE based on the measured results. The backup UAV UE is activated from the BS or the master UAV UE side when the measured results indicate that an incident is occurring in the specified UAV UE.

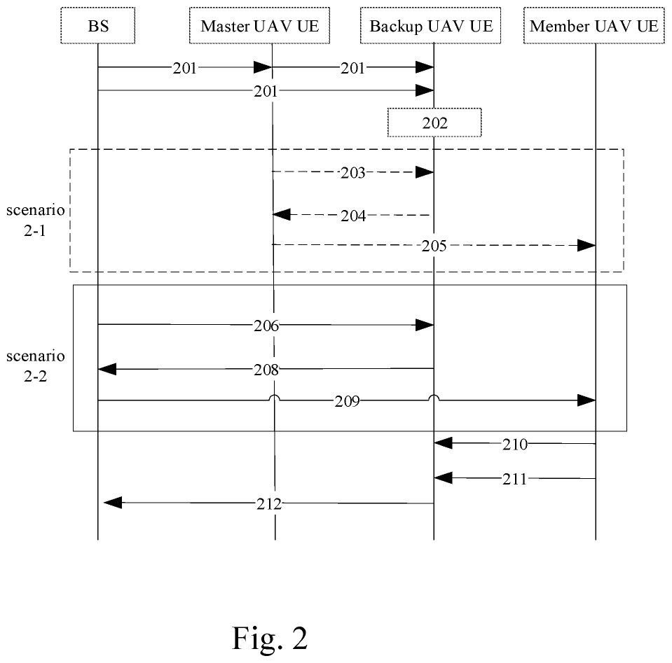

FIG. 2 illustrates a flow chart of an exemplary UAV UE replacement process according to some embodiments of the present disclosure. More specifically, the UAV UE replacement process relates to the replacement of the master UAV UE in a UAV swarm.

There are at least two different scenarios for replacing the master UAV UE. The first scenario is that: the master UAV UE is determined to stop operation by the application layer, the BS, or the master UAV UE itself. In this scenario, the master UAV UE can be informed to prepare or autonomously prepare the replacement in advance from the master UAV UE side. In the second scenario, the master UAV UE stops operation suddenly due to some incidents. In this scenario, the replacement is unpredictable, and the master UAV UE cannot be involved in the replacement process since it has lost the capability to perform normal operation. Both scenarios are described in FIG. 2, which are referred to as scenario 2-1 (method steps in the dashed box are dedicated for scenario 2-1) and scenario 2-2 (method steps in the solid box are dedicated for scenario 2-2) respectively.

In both scenarios, four entities may be involved in the replacement process, which are: the BS, the master UAV UE of a UAV swarm, the backup UAV UE which is used to replace the master UAV UE, and the member UAV UE of the UAV swarm.

In step 201, the BS transmits the backup UAV UE configuration to the master UAV UE, and the master UAV UE forwards the backup UAV UE configuration to the backup UAV UE (e.g., in the case that the backup UAV UE is a member UAV UE in a UAV swarm managed by the master UAV UE). Alternatively, the BS may transmit the backup UAV UE configuration to the backup UAV UE directly in step 201 (e.g., in the case that the backup UAV UE can directly communicate with the BS). The backup UAV UE configuration may configure the backup UAV UE as a backup UAV UE for the master UAV UE in the UAV swarm, or a backup UAV UE for any UAV UE in the UAV swarm, or a backup UAV UE for any UAV UE in multiple UAV swarms.

In step 202, the backup UAV UE is activated by the application layer, the BS, or the master UAV UE, as described above, when an incident is detected.

Steps 203-205 relate to the above scenario 2-1, i.e. the master UAV UE prepares the replacement of the master UAV UE in advance. In step 203, the master UAV UE initiates the replacement and transmits a first replacement command to the backup UAV UE. The first replacement command may include information for the backup UAV UE to prepare the replacement (e.g., information related to the master UAV UE). Specifically, the information may include at least one of the following:
1. an ID of the master UAV UE, e.g. Cell-Radio Network Temporary Identifier (C-RNTI);
2. location information of the master UAV UE, which may include a real-time position and corresponding speed in horizontal and vertical;
3. a flight path of the master UAV UE;
4. an identification and a flight path of the UAV swarm;
5. a UE context of the master UAV UE, e.g., protocol data unit (PDU) session related information (e.g., quality of service (QOS) flow level QoS profiles) of the master UAV UE, current QoS flows to Data Radio Bearer (DRB) mapping rules applied to the master UAV UE, and/or type (master UAV UE or member UAV UE) of the UAV UE to be replaced;
6. slice related information for accurate Access and Mobility Management Function (AMF) selection at radio access network (RAN) side, e.g., temp ID for AMF selection used by the master UAV UE, requested Network Slice Selection Assistance Information (NSSAI) of the master UAV UE, and/or ongoing slice IDs used by the master UAV UE;
7. IDs of one or more member UAV UEs in the UAV swarm managed by the master UAV UE, e.g. C-RNTIs of the one or more member UAV UEs in the UAV swarm;
8. location information of the one or more member UAV UEs in the UAV swarm managed by the master UAV UE, which may include a real-time position and corresponding speed in horizontal and vertical;
9. flight paths of the one or more member UAV UEs in the UAV swarm managed by the master UAV UE;
10. UE capabilities for different radio access technologies (RATs) of one or more member UAV UEs in the UAV swarm managed by the master UAV UE; and
11. UE reported measurement information received at the master UAV UE side.

In step 204, the backup UAV UE sends an acknowledgement (ACK) as the response to the first replacement command to the master UAV UE, which may include one or more of the following information of the backup UAV UE:
1. UE capabilities for different RATs;
2. location information, which may include a real-time position and corresponding speed in horizontal and vertical; and
3. one or more measurement results, for example, the sidelink Reference Signal Receiving Power (SL-RSRP) measurement between the master UAV UE and the backup UAV UE.

Alternatively, the ACK transmitted in step 204 may be a confirmation, and the above information can be transmitted in a separate step (not shown in FIG. 2).

In step 205, the master UAV UE triggers the replacement by broadcasting or sending a second replacement command, e.g. an RRC command, to one or more member UAV UEs in the UAV swarm, which may include the information required to access or connect to the backup UAV UE (e.g., information related to the backup UAV UE). The information may include at least one of the following:
1. an ID of the backup UAV UE;
2. location information of the backup UAV UE, which may include a real-time position and corresponding speed in horizontal and vertical;
3. a set of dedicated resources or shared resources to establish the sidelink radio connection between backup UAV UE and one or more member UAV UEs in the UAV swarm;
4. an association between the resources and the member UAV UEs, and
5. an indication to clear the transmission with the master UAV UE (i.e., an indication to stop transmission with the master UAV UE), etc.

The second replacement command to member UAV UEs is triggered when received location information report or measurement results indicate that the backup UAV UE is within a specified normal range, e.g., location information of the backup UAV UE is within a specified normal range or a measurement result of the backup UAV UE is within a specified normal range.

In step 210, the member UAV UE in the same UAV swarm as the master UAV UE to be replaced triggers sidelink unicast establishment with the backup UAV UE upon receiving the second replacement command, e.g., using the resources indicated in the second replacement command.

In step 211, the member UAV UE transmits measurement or location information report to the backup UAV UE. In step 212, the backup UAV UE transmits the measurement or location information report received from member UAV UE(s) to the BS when the sidelink unicast connection between the member UAV UE(s) and the backup UAV UE is established.

Steps 206, 208, and 209 relate to the above scenario 2-2, i.e. the master UAV UE cannot prepare the replacement of the master UAV UE. In step 206, the BS transmits a first replacement command to the backup UAV UE with necessary information. The information may be identical to the information transmitted by the master UAV UE in step 203, and the details are omitted here.

In step 208, the backup UAV UE sends an acknowledge (ACK) as the response to the first replacement command to the BS, which may include one or more of the following information of the backup UAV UE: UE capabilities for different RATs; location information (including real-time positions and corresponding speeds in horizontal and vertical); and one or more measurement results, for example, Reference Signal Receiving Power (RSRP) measurement between the backup UAV UE and the BS. Alternatively, the ACK transmitted in step 208 may be a confirmation, and the above information can be transmitted in a separate step (not shown in FIG. 2).

In step 209, the BS triggers the replacement by broadcasting or sending a second replacement command, such as an RRC command, to one or more member UAV UEs in the UAV swarm, which may include the information required to access or connect to the backup UAV UE. The information is similar to the information transmitted from the master UAV UE to the member UAV UE in step 205.

The second replacement command to member UAV UEs is triggered when received location information report or measurement results indicate that the backup UAV UE is within a specified normal range, e.g., the location information of the backup UAV UE is within a specified normal range or a measurement result of the backup UAV UE is within a specified normal range.

Then the process also proceeds to steps 210-212.

In scenario 2-2, the master UAV UE is not involved in the procedure of UAV UE replacement, and during this procedure, the member UAV UEs which are previously managed by the master UAV UE are managed by the BS until the backup UAV UE is available.

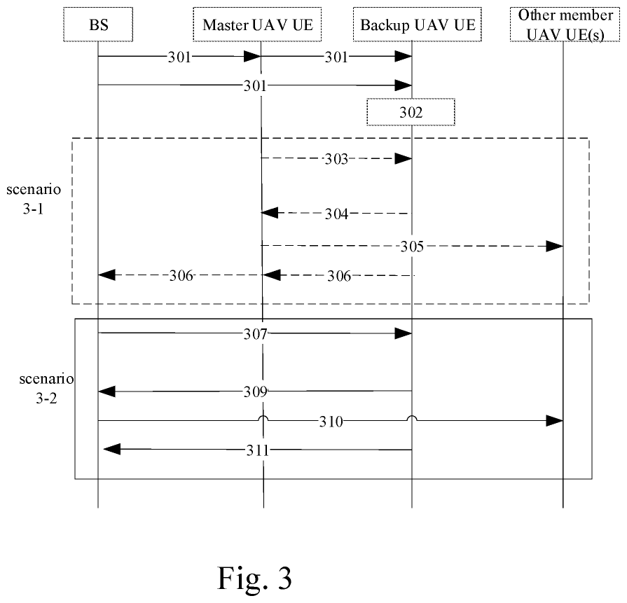

FIG. 3 illustrates a flow chart of an exemplary UAV UE replacement process according to some embodiments of the present disclosure. More specifically, the UAV UE replacement process relates to the replacement of a member UAV UE in a UAV swarm.

There are at least two different scenarios for replacing the member UAV UE. The first scenario is that: the UAV UE replacement is managed by the master UAV UE. In the second scenario, the UAV UE replacement is managed by the BS. Both scenarios are described in FIG. 3, which are referred to as scenario 3-1 (method steps in the dashed box are dedicated for scenario 3-1) and scenario 3-2 (method steps in the solid box are dedicated for scenario 3-2) respectively.

In both scenarios, four entities may be involved in the replacement process, which are: the BS, the master UAV UE of a UAV swarm, the backup UAV UE which is used to replace the member UAV UE, and other member UAV UE(s) in the UAV swarm different from the member UAV UE which is to be replaced.

In step 301, the BS transmits the backup UAV UE configuration to the master UAV UE, and the master UAV UE forwards the backup UAV UE configuration to the backup UAV UE (e.g., in the case that the backup UAV UE is a member UAV UE in a UAV swarm managed by the master UAV UE). Alternatively, the BS may transmit the backup UAV UE configuration to the backup UAV UE directly in step 301 (e.g., in the case that the backup UAV UE can directly communicate with the BS).

In step 302, the backup UAV UE is activated by the application layer, the BS, or the master UAV UE, as described above, when an incident is detected.

Steps 303-306 relate to the above scenario 3-1, i.e. the master UAV UE manages the replacement of the member UAV UE. In step 303, the master UAV UE initiates the replacement and transmits a first replacement command to the backup UAV UE. The first replacement command may include information of the member UAV UE which is about to be replaced, and this information helps the backup UAV UE to prepare the replacement. Specifically, the information may include at least one of the following:
1. an ID of the member UAV UE, e.g. C-RNTI;
2. location information of the member UAV UE, which may include a real-time position and corresponding speed in horizontal and vertical;
3. a flight path of the member UAV UE;
4. an identification and a flight path of the UAV swarm;
5. a UE context of the member UAV UE, e.g. PDU session related information (e.g., QoS flow level QoS profiles) of the member UAV UE, current QoS flows to DRB mapping rules applied to the member UAV UE, and/or type (master UAV UE or member UAV UE) of the UAV UE to be replaced; and
6. slice related information for accurate AMF selection at RAN side, e.g. Temp ID for AMF selection used by the member UAV UE, requested NSSAI of the member UAV UE, and/or ongoing slice IDs used by the member UAV UE.

Upon receiving the first replacement command, the backup UAV UE triggers an RRC connection with the master UAV UE and in step 304, the backup UAV UE transmits an ACK as the response to the first replacement command to the master UAV UE, which may include one or more of the following information of the backup UAV UE:
1. UE capabilities for different RATs;
2. location information, which may include a real-time position and corresponding speed in horizontal and vertical; and
3. One or more measurement results of the backup UAV UE, for example, the SL-RSRP measurement between the master UAV UE and backup UAV UE.

Alternatively, the ACK transmitted in step 304 may be a confirmation, and the above information can be transmitted in a separate step (not shown in FIG. 3).

In step 305, the master UAV UE broadcasts or transmits a second replacement command, e.g. an RRC command, to member UAV UE(s) in the UAV swarm, which may include the information of the backup UAV UE, if the measurement results, for example, an RSRP value or location information from the backup UAV UE, is within a specified normal range.

The information may include at least one of the following:
1. an ID of the backup UAV UE;
2. location information of the backup UAV UE, which may include a real-time position and corresponding speed horizontal and vertical;
3. an ID of the member UAV UE which is to be replaced; and
4. an indication to clear the transmission with the member UAV UE (i.e., an indication to stop transmission with the member UAV UE), etc.

The information may further include a set of dedicated resources or shared resources, which are used for the backup UAV UE to trigger sidelink radio link establishment with other member UAV UE(s) in the UAV swarm.

In step 306, the backup UAV UE transmits measurement or location information report to the master UAV UE as other member UAV UE(s) when the sidelink unicast connection is established, and the master UAV UE forwards the measurement or location information report to the BS.

Steps 307, 309, 310, and 311 relate to the above scenario 3-2, i.e. the BS manages the replacement of the member UAV UE. In step 307, the BS initiates the replacement and transmits a first replacement command to backup UAV UE with necessary information. The information may be identical to the information transmitted by the master UAV UE in step 303, and the details are omitted here.

Upon receiving the first replacement command, the backup UAV UE triggers an RRC connection with the BS and in step 309, the backup UAV UE transmits an ACK as the response to the first replacement command to the BS, which may include similar information of the backup UAV UE as that transmitted in step 304.

Alternatively, the ACK transmitted in step 309 may be a confirmation, and the above information can be transmitted in a separate step (not shown in FIG. 3).

In step 310, the BS broadcasts or transmits a second replacement command, e.g. an RRC command, to member UAV UE(s) in the UAV swarm, which may include the same information as that transmitted in step 305.

In step 311, the backup UAV UE transmits measurement or location information report as other member UAV UE(s) in the UAV swarm to the BS.

When the UAV UE replacement procedure is over, the BS or the master UAV UE determines whether the UAV UE replacement in the UAV swarm is successful or not.

Specifically, the UAV UE replacement is successful when the following two conditions are met:
1. The sidelink unicast connection to the backup UAV UE is successfully completed; and
2. The measurement results or location information report related to the backup UAV UE is within a normal range.

Regarding condition 1, the sidelink unicast connection to the backup UAV UE is successfully completed when the sidelink unicast connection between the backup UAV UE and the master UAV UE is established successfully (e.g. a sidelink unicast connection is established between a backup member UAV UE and the master UAV UE), or when the sidelink unicast connection between the backup UAV UE and member UAV UE(s) is established successfully (e.g. a sidelink unicast connection is established between a backup master or member UAV UE and the member UAV UE(s) in the UAV swarm).

Regarding condition 2, whether the measurement results or location information report related to the backup UAV UE is within a normal rang is determined by at least one of the following:
a) The backup UAV UE transmits a complete message containing the measurement or location information report to the BS or to the master UAV UE after the connection establishment, and the measurement or location information report indicates that the measured results are within a specified normal range. For example, a backup member UAV UE transmits the complete message to the master UAV UE, which indicates that the backup member UAV UE is within a specified location range;
b) The measurement reports from member UAV UE(s) to the master UAV UE or the BS indicates that the SL-RSRP between the member UAV UE(s) and the backup UAV UE is within a specified normal range; or
c) The master UAV UE measures that the SL-RSRP between itself and the backup UAV UE is within a specified normal range.

If condition 1 and condition 2 are not both satisfied, the UAV UE replacement is considered as unsuccessful. In this case, the BS may transmit the failure or incidents report to member UAV UEs in the UAV swarm, which indicates an ID and location information of the replaced UAV UE and an indication to clear the transmission with the replaced UAV UE. The BS may also transmit a failure report for the UAV UE replacement to the application layer.

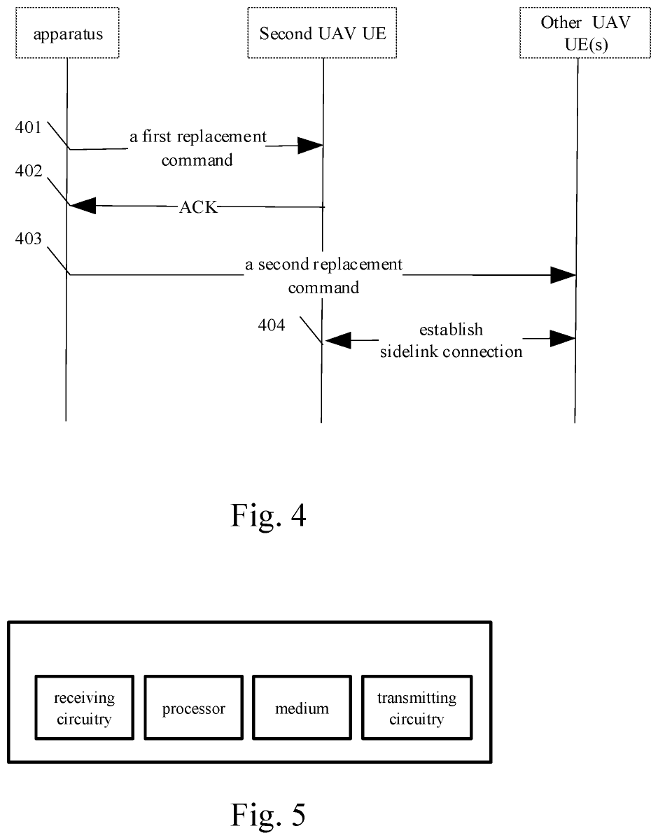

FIG. 4 illustrates a flow chart of an exemplary method for wireless communication according to some embodiments of the present disclosure.

In step 401, an apparatus transmits a first replacement command to a second UAV UE, wherein the second UAV UE is to replace a first UAV UE in a UAV swarm. The first replacement command includes first information related to the first UAV UE to be replaced by the second UAV UE. For example, the apparatus may be a BS or the master UAV UE in the UAV swarm, and the second UAV UE may be a backup UAV UE.

The first information may include at least one of: a UE identifier, location information, and a flight path of the first UAV UE; an identification and a flight path of the UAV swarm; a UE context of the first UAV UE; slice related information of the first UAV UE, a UE identifier, location information, a flight path, and UE capabilities for different RATs of a UAV UE of the UAV swarm other than the first UAV UE; or one or more measurement reports received by the first UAV UE.

In step 402, after receiving the first replacement command, the second UAV UE transmits an ACK to the apparatus. The ACK may include at least one of the following: UE capabilities for different RATs of the second UAV UE, location information of the second UAV UE, which may include a real-time position and corresponding speed in horizontal and vertical, or one or more measurement results of the second UAV UE. Alternatively, the ACK is transmitted along with at least one of the following: UE capabilities for different RATs of the second UAV UE, location information of the second UAV UE, which may include a real-time position and corresponding speed in horizontal and vertical, or one or more measurement results of the second UAV UE.

In step 403, in response to receiving the ACK to the first replacement command from the second UAV UE, the apparatus transmits a second replacement command to other UAV UE(s), and the second replacement command includes second information related to the second UAV UE. The second information may include at least one of: a UE identifier of the second UAV UE, location information of the second UAV UE, a set of resources for establish a sidelink connection with the second UAV UE, an association between the set of resources and the one or more UAV UEs of the UAV swarm, or an indication to stop transmission with the first UAV UE. The other UAV UE(s) may establish a sidelink connection with the second UAV UE in step 404, e.g., using the resources indicated in the second replacement command.

In some embodiments, the second replacement command is transmitted when location information of the second UAV UE is within a first range or a measurement result of the second UAV UE is within a second range. That is, when the backup UAV UE is within the range, it can be used for replacing the first UAV UE.

In some embodiments, the apparatus may transmit a configuration to the second UAV UE to configure the second UAV UE as a backup UAV UE for any UAV UE of the UAV swarm, a backup UAV UE for the first UAV UE of the UAV swarm, or a backup UAV UE for any UAV UE of a plurality of UAV swarms comprising the UAV swarm. For example, as shown in FIG. 1B, the second UAV UE may be configured as the backup UAV UE for any UAV UE of the UAV swarm in FIG. 1B, or the backup UAV UE for the master UAV UE of the UAV swarm, or the backup UAV UE for any UAV UE of any UAV swarm. The configuration may be transmitted in a dedicated RRC signaling or a SIB. Alternatively, the configuration may be transmitted from a UAV UE central controller.

In some embodiments, the apparatus performs incident detection, determines the first UAV UE and the second UAV UE based on a result of incident detection, and transmits an indication to activate the second UAV UE. For example, a master UAV UE detects the incident that the battery of the master UAV UE is low, and it transmits an indication to activate the backup UAV UE, so as to replace the master UAV UE itself. The master UAV UE may further report the determined first UAV UE and the determined second UAV UE to a base station.

When the UAV UE replacement procedure is over, the apparatus determines a successful replacement of the first UAV UE by the second UAV UE based on: i) a successful sidelink connection between the second UAV UE and one or more UAV UEs of the UAV swarm; and ii) a measurement result related to the second UAV UE within a predefined range. The measurement result includes measured location information of the second UAV UE, or an SL-RSRP of the second UAV UE for the established sidelink connection.

In some embodiments, the apparatus further receives the measurement result from the second UAV UE or the one or more UAV UEs of the UAV swarm. For example, in step 311, the backup UAV UE transmits the measurement result to the BS.

In some embodiments, the apparatus further performs a measurement to obtain the measurement result. For example, the apparatus measures the SL-RSRP between itself and the backup UAV UE, so as to determine whether the UAV UE replacement is successful or not.

In some embodiments, the apparatus further transmits a replacement completion indication to the one or more UAV UEs of the UAV swarm when it is determined that the replacement of the first UAV UE with the second UAV UE is successful, wherein the replacement completion indication includes a UE identifier and location information of the second UAV UE, and an indication indicating that the second UAV UE has replaced the first UAV UE and joined in the UAV swarm.

In some embodiments, the apparatus further transmits a replacement failure indication to the one or more UAV UEs of the UAV swarm when it is determined that the replacement of the first UAV UE with the second UAV UE is not successful, wherein the replacement failure indication includes a UAV UE identifier and location information of the first UAV UE and an indication to stop transmission with the first UAV UE.

FIG. 5 illustrates an exemplary block diagram of an apparatus according to some embodiments of the present disclosure. The apparatus may be or included in a UAV UE or a BS, which can implement any method as described with respect to FIG. 2, 3, or 4.

The apparatus may include at least one receiving circuitry, at least one processor, and at least one transmitting circuitry. In an embodiment, the apparatus may further include at least one medium (e.g. non-transitory computer-readable medium) having stored thereon computer-executable instructions. The at least one processor may be coupled to the at least one non-transitory computer-readable medium, the at least one receiving circuitry and the at least one transmitting circuitry. The computer executable instructions can be programmed to implement a method (e.g., the method as illustrated in FIG. 2, 3, or 4) with the at least one receiving circuitry, the at least one transmitting circuitry and the at least one processor. Although in FIG. 5, elements such as receiving circuitry, transmitting circuitry, non-transitory computer-readable medium, and processor are described in the singular, the plural is contemplated unless limitation to the singular is explicitly stated. In some embodiments of the present disclosure, the at least one receiving circuitry and the at least one transmitting circuitry may be combined into a single device, such as a transceiver. In certain embodiments of the present disclosure, the apparatus may further include an input device, a memory, and/or other components.

In some embodiments, the apparatus may include a processor and a transceiver coupled to the processor, wherein the processor is configured to: transmit, via the transceiver, a first replacement command including first information related to a first UAV UE to a second UAV UE, wherein the second UAV UE is to replace the first UAV UE from an UAV swarm including a plurality of UAV UEs; and in response to receiving an acknowledgement to the first replacement command from the second UAV UE, transmit, via the transceiver, a second replacement command including second information related to the second UAV UE to one or more UAV UEs of the UAV swarm other than the first UAV UE.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method for replacing an unmanned aerial vehicle (UAV) user equipment (UE) within a UAV swarm comprising a plurality of UAV UEs, the method comprising:
transmitting a first replacement command comprising first information related to a first UAV UE to a second UAV UE, wherein the second UAV UE is to replace the first UAV UE from the UAV swarm; and
in response to receiving an acknowledgement to the first replacement command from the second UAV UE, transmitting a second replacement command comprising second information related to the second UAV UE to one or more UAV UEs of the UAV swarm other than the first UAV UE.

2. The method of claim 1, wherein the acknowledgement comprises or is received along with at least one of the following:
UE capabilities for different radio access technologies (RATs) of the second UAV UE,
location information of the second UAV UE, or
one or more measurement results of the second UAV UE.

3. The method of claim 1, further comprising transmitting a configuration to the second UAV UE to configure the second UAV UE as a backup UAV UE for any UAV UE of the UAV swarm, a backup UAV UE for the first UAV UE of the UAV swarm, or a backup UAV UE for any UAV UE of a plurality of UAV swarms comprising the UAV swarm.

4. The method of claim 1, further comprising:
determining the first UAV UE and the second UAV UE based on a result of incident detection or control command from a central controller; and
transmitting an indication to activate the second UAV UE.

5. The method of claim 1, wherein the first information related to the first UAV UE comprises at least one of the following parameters:
i. a UE identifier, location information, and a flight path of the first UAV UE;
ii. an identification and a flight path of the UAV swarm;
iii. a UE context of the first UAV UE;
iv. slice related information of the first UAV UE;
V. a UE identifier, location information, a flight path, and UE capabilities for different radio access technologies (RATs) of a UAV UE of the UAV swarm other than the first UAV UE; or
vi. one or more measurement reports received by the first UAV UE.

6. The method of claim 1, wherein the second information related to the second UAV UE comprises at least one of: a UE identifier of the second UAV UE, location information of the second UAV UE, a set of resources for establish a sidelink connection with the second UAV UE, an association between the set of resources and the one or more UAV UEs of the UAV swarm, or an indication to stop transmission with the first UAV UE.

7. The method of claim 1, further comprising:
determining a successful replacement of the first UAV UE by the second UAV UE based on:
a successful sidelink connection between the second UAV UE and one or more UAV UEs of the UAV swarm; and
a measurement result related to the second UAV UE within a predefined range.

8. The method of claim 7, further comprising transmitting a replacement completion indication to the one or more UAV UEs of the UAV swarm when it is determined that the replacement of the first UAV UE with the second UAV UE is successful, wherein the replacement completion indication comprises a UE identifier and location information of the second UAV UE, and an indication indicating that the second UAV UE has replaced the first UAV UE and joined in the UAV swarm.

9. The method of claim 7, further comprising transmitting a replacement failure indication to the one or more UAV UEs of the UAV swarm when it is determined that the replacement of the first UAV UE with the second UAV UE is not successful, wherein the replacement failure indication comprises a UE identifier and location information of the first UAV UE and an indication to stop transmission with the first UAV UE.

10.-14. (canceled)

15. An apparatus, comprising:
a processor; and
a transceiver coupled to the processor, wherein the processor is configured to:
transmit, via the transceiver, a first replacement command comprising first information related to a first UAV UE to a second UAV UE, wherein the second UAV UE is to replace the first UAV UE from an UAV swarm comprising a plurality of UAV UEs; and
in response to receiving an acknowledgement to the first replacement command from the second UAV UE, transmit, via the transceiver, a second replacement command comprising second information related to the second UAV UE to one or more UAV UEs of the UAV swarm other than the first UAV UE.

16. The apparatus of claim 15, wherein the acknowledgement comprises or is received along with at least one of the following:
UE capabilities for different radio access technologies (RATs) of the second UAV UE,
location information of the second UAV UE, or
one or more measurement results of the second UAV UE.

17. The apparatus of claim 15, wherein the processor is further configured to cause the apparatus to:
transmit a configuration to the second UAV UE to configure the second UAV UE as a backup UAV UE for any UAV UE of the UAV swarm, a backup UAV UE for the first UAV UE of the UAV swarm, or a backup UAV UE for any UAV UE of a plurality of UAV swarms comprising the UAV swarm.

18. The apparatus of claim 15, wherein the processor is further configured to cause the apparatus to:
determine the first UAV UE and the second UAV UE based on a result of incident detection or control command from a central controller; and
transmit an indication to activate the second UAV UE.

19. The apparatus of claim 15, wherein the first information related to the first UAV UE comprises at least one of the following parameters:
i. a UE identifier, location information, and a flight path of the first UAV UE;
ii. an identification and a flight path of the UAV swarm;
iii. a UE context of the first UAV UE;
iv. slice related information of the first UAV UE;
v. a UE identifier, location information, a flight path, and UE capabilities for different radio access technologies (RATs) of a UAV UE of the UAV swarm other than the first UAV UE; or
vi. one or more measurement reports received by the first UAV UE.

20. The apparatus of claim 15, wherein the second information related to the second UAV UE comprises at least one of: a UE identifier of the second UAV UE, location information of the second UAV UE, a set of resources for establish a sidelink connection with the second UAV UE, an association between the set of resources and the one or more UAV UEs of the UAV swarm, or an indication to stop transmission with the first UAV UE.

21. The apparatus of claim 15, wherein the processor is further configured to cause the apparatus to determine a successful replacement of the first UAV UE by the second UAV UE based on:
a successful sidelink connection between the second UAV UE and one or more UAV UEs of the UAV swarm; and
a measurement result related to the second UAV UE within a predefined range.

22. The apparatus of claim 21, wherein the processor is further configured to cause the apparatus to:
transmit a replacement completion indication to the one or more UAV UEs of the UAV swarm when it is determined that the replacement of the first UAV UE with the second UAV UE is successful, wherein the replacement completion indication comprises a UE identifier and location information of the second UAV UE, and an indication indicating that the second UAV UE has replaced the first UAV UE and joined in the UAV swarm.

23. The apparatus of claim 21, wherein the processor is further configured to cause the apparatus to:
transmit a replacement failure indication to the one or more UAV UEs of the UAV swarm when it is determined that the replacement of the first UAV UE with the second UAV UE is not successful, wherein the replacement failure indication comprises a UE identifier and location information of the first UAV UE and an indication to stop transmission with the first UAV UE.

24. An apparatus for replacing an unmanned aerial vehicle (UAV) user equipment (UE) within a UAV swarm comprising a plurality of UAV UEs, the apparatus comprising:
a processor; and
a transceiver coupled to the processor, wherein the processor is configured to:
receive, at a second UAV UE, a first replacement command comprising first information related to a first UAV UE, wherein the second UAV UE is to replace the first UAV UE from the UAV swarm;
transmit an acknowledgement to the first replacement command; and
establish a sidelink connection between the second UAV UE and one or more UAV UEs of the UAV swarm other than the first UAV UE.

25. A processor for wireless communication, comprising:
at least one controller coupled with at least one memory and configured to cause the processor to:
receive, at a second unmanned aerial vehicle (UAV) user equipment (UE), a first replacement command comprising first information related to a first UAV UE within a UAV swarm comprising a plurality of UAV UEs,
wherein the second UAV UE is to replace the first UAV UE from the UAV swarm;
transmit an acknowledgement to the first replacement command; and
establish a sidelink connection between the second UAV UE and one or more UAV UEs of the UAV swarm other than the first UAV UE.
